(19) United States
(12) Patent Application Publication
(10) Pub. No.: US 2010/0141445 A1
(43) Pub. Date: Jun. 10, 2010

(54) Multi-Mode Commissioning/Decommissioning of Tags for Managing Assets

(75) Inventors: Nalini Venkatasubramaniyam, Union City, CA (US); Nick Cova, Salt Lake, UT (US)

Correspondence Address: FISH & RICHARDSON P.C., PO BOX 1022, MINNEAPOLIS, MN, 55440-1022, US

(73) Assignee: Savi Networks Inc.

(21) Appl. No.: 12/330,346

(22) Filed: Dec. 8, 2008

(51) Int. Cl. G08B 13/14; G06F 7/04; G06F 17/20; H04W 4/00; H04M 3/42

(52) U.S. Cl. 340/571; 340/5.8; 704/8; 455/466; 455/414.1; 704/E15.003

(57) ABSTRACT

Multi-mode commissioning/decommissioning of a wireless monitoring device (Tag) for managing assets and shipments is disclosed. Users can request commissioning, status resets and decommissioning of Tags using multiple modes of communication. The users are authenticated by an information service that receives the requests. Responsive to a successful authentication of a user, the information service receives a tag identifier and an asset identifier from the user. A tracking application associates the Tag identifier and the asset identifier. After the Tag is associated with the asset, the tracking application can successfully track the geographic location and status data of the asset from the Tag. The location data can be used by the tracking application to track assets in real-time. The status data and location data can be used by the tracking application to detect and verify tamper conditions, including tamper alerts triggered by geo-fences, authorized inspection of the asset, and environmental exceptions.

### TECHNICAL FIELD

This subject matter is related generally to managing in-transit assets and shipments in real-time.

### BACKGROUND

A wireless monitoring device (Tag), which can use various technologies such as GPS, RFID, and GPRS, can be used to track movements of an asset (e.g., a shipping container) on which the Tag is mounted. However, until an association is made between the Tag and the asset systematically, a tracking application cannot intelligently track the asset's journey through the supply chain.

Dedicated hand-held devices are often used to associate Tags to assets. The use of a dedicated hand-held device for commissioning can be challenging because the hand-held device needs to be pre-positioned along with the Tag. Also, the initial investment, maintenance and training costs associated with dedicated hand-held devices can be prohibitively expensive.

### SUMMARY

Multi-mode commissioning/decommissioning of Tags for managing assets is disclosed. Users can request commissioning and decommissioning of Tags using multiple modes of communication. The users are authenticated by an information service that receives the requests. Responsive to a successful authentication of a user, the information service receives a Tag identifier and an asset identifier from the user. A tracking application associates the Tag identifier and the asset identifier. After the Tag is associated with the asset, the tracking application can successfully track the geographic location and status data of the asset via the Tag. The location data can be used by the tracking application to track assets in real-time. The status data and location data can be used by the tracking application to detect and verify tamper conditions, including tamper alerts triggered by geo-fences, authorized inspection of the asset, and environmental exceptions.

### BRIEF DESCRIPTION OF THE DRAWINGS

FIG. 1 is a block diagram of an example Zero Client Commissioning system.

FIG. 2 is a flow diagram of an example process performed by the Tag of FIG. 1.

FIG. 3 is a flow diagram of an example process performed by the location/status server of FIG. 1.

FIG. 4 is a flow diagram of an example process performed by a tracking application implementing business logic.

### DETAILED DESCRIPTION

### Example ZCC System

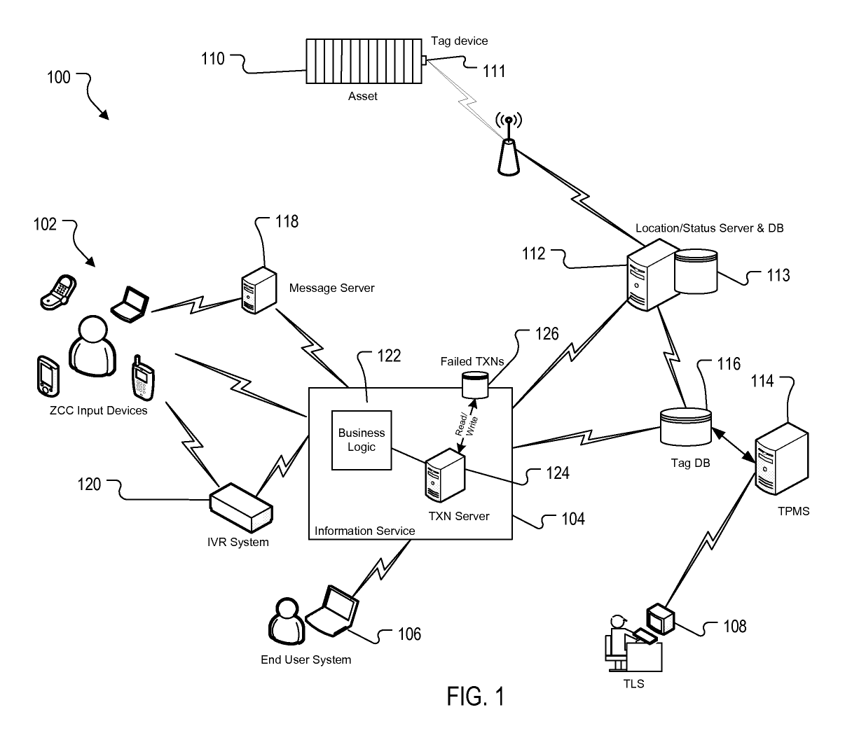

FIG. 1 is a block diagram of an example Zero Client Commissioning (ZCC) system 100. ZCC is the association of a Tag to an asset (e.g., a shipping container) without using a dedicated device. The system 100 commissions (associates) Tags to assets, decommissions (disassociates) Tags from assets, provides notification of authorized openings of assets (e.g., opening by a customs agent), clears tamper states, and clears various environmental exceptions (e.g., the exceeding of temperature or humidity thresholds).

In some implementations, the system 100 can include one or more ZCC input devices 102, an information service 104, one or more end user systems 106, a Tag Logistics System (TLS) 108, one or more assets 110, one or more Tags 111 affixed or coupled to the one or more assets 110, a location/status server 112, a location/status database 113, a Tag Pool Management System (TPMS) 114, a tag database 116, a message server 118, an Integrated Voice Response (IVR) system 120, a transaction (TXN) server 124, and a failed transaction database 126.

The ZCC input devices 102 can be any suitable communication device, including but not limited to mobile phones, land phones, email devices, portable computers, etc. The ZCC input devices 102 communicate with the information service 104 using a variety of communication modes, including but not limited to: IVR, Short Message Service (SMS), email, hand-held application, Web interface, and Electronic Data Interchange (EDI) or any other form of electronic message sharing. The ZCC input devices 102 can be operated by various actors having various roles in the supply chain, including but not limited to: dock workers, longshoreman, logistics service providers, freight forwarders, field agents, customs agents and any other personnel involved in the tracking of an asset.

The information service 104 allows end user systems 106 to track the status of assets 110 in real-time. The transaction server 124 runs a tracking application that receives location/status transaction messages or reports from the location/status server 112 and applies business logic 122 to the transactions for validating and maintaining associations between Tag identifiers and asset identifiers. Successful transactions are posted against assets and Tags. Failed transactions and reason codes are written to an exception queue in the failed transaction database 126.

The information service 104 can include a Web server (not shown) for providing Web forms to end user systems 106 (e.g., a browser on a PC or mobile device). The Web forms provide an input mechanism for a user to commission or decommission Tags and to receive real-time tracking and status information regarding assets. An example information service 104 is SaviTrak™ provided by Savi Networks, LLC (Mt. View, Calif.).

The Tag 111 can be, for example, a GPS/GPRS electronic device that can be affixed or coupled to an asset 110 to be tracked, such as an international shipping container. The Tag 111 wakes up periodically to initiate communication with the location/status server 112 and to send location/status transaction messages to the location/status server 112. The location and status information can be stored in the location/status database 113. In some implementations, the Tag 111 processes commands (e.g., Over-the-Air (OTA) commands) received from the location/status server 112. The Tag 111 reports various tamper states. For example, the Tag 111 can report when a vertical or horizontal bolt securing the Tag 111 to a container is cut. Other types of tampers can also be detected (e.g., shock intrusion). Tags 111 can also monitor environmental variables (e.g., temperature, humidity) and report on exceptions to the location/status server 112. An example Tag 111 is the Savi Networks SN-LSE-01, which is a GPS-based Location+Security+Environmental Tag.

The location/status server 112 periodically receives reports from the Tag 111. The reports include location and status information. The location/status server 112 also constructs and sends commands to the Tag 111. Some transaction management functions performed by the location/status server 112 include but are not limited to: checking incoming transactions for syntax errors and population of mandatory fields, sorting or sequencing reports logically before forwarding the reports to the information service 104, and constructing output transactions that comply with processing logic.

In some implementations, the TPMS 114 maintains an inventory of Tags 111 in the tag database 116. The TPMS 114 also maintains the association of the asset identifier (ID) and Tag ID and the logical state or status of the Tag 111, such as ‘In Use,’ ‘Available,’ ‘Begin Journey’, ‘End Journey’, etc. The TPMS 114 also maintains the allocation and availability of Tags 111 for logistics and pre-positioning purposes.

In some implementations, the TPMS 114 allows personnel operating the TLS 108 to perform housekeeping functions, such as Tag forecasts, ordering new Tags, detecting lost Tags, billing management, salvage and environmental disposal of failed Tags, inventory tracking, customer help desk and financial accounting. The TPMS 114 allows personnel operating the TLS 108 to monitor the state of a Tag 111 ‘in journey’, and trouble shoot causes for failure in communicating with the location/status server 112 and locate lost Tags. The TPMS 114 provides analytic tools to monitor Tag network performance (e.g., GPS/GPRS coverage/roaming area for trade lanes).

The ZCC system 100 is one example infrastructure for implementing ZCC functions. Other infrastructures are also possible which contain more or fewer subsystems or components than shown in FIG. 1. For example, one or more of the servers or databases shown in FIG. 1 can be combined into a single server or database.

### Example Process Performed by Tag

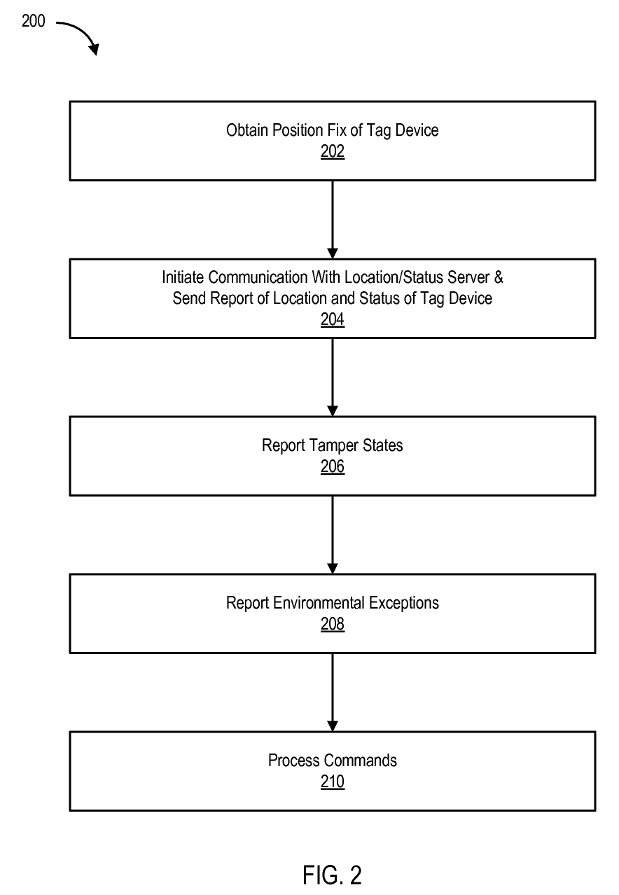

FIG. 2 is a flow diagram of an example process 200 performed by a Tag (e.g., Tag 111) operating in a ZCC system 100. The steps of process 200 need not occur sequentially or in the order described below.

In some implementations, the process 200 begins when the Tag obtains a position fix (202). The position fix can be, for example, a GPS or GPRS position fix. The position fix can be obtained periodically based on a schedule (e.g., every 30 minutes) or in response to a trigger event (e.g., a security or environmental alert).

The Tag periodically wakes up and initiates communication with a location/status server and sends a report to the location/status server (204). The report can include the current location and status of the Tag. For example, the Tag can identify and report a first wakeup to indicate a ‘Begin Journey’ status.

In some implementations, the Tag detects and reports tamper conditions (206). An example tamper condition can be if a vertical or horizontal bolt securing the container is cut. Other tamper conditions can also be monitored (e.g., presence of ambient light).

In some implementations, the Tag monitors environmental variables and reports on exceptions (208). An example exception can be a temperature or humidity reading exceeding a predefined threshold value. The Tag can include various sensors (e.g., temperature, acceleration (shock) and humidity sensors) for detecting environmental exceptions.

The Tag processes OTA commands, if any, received from the location/status server (210).

### Example Process Performed by Location/Status Server

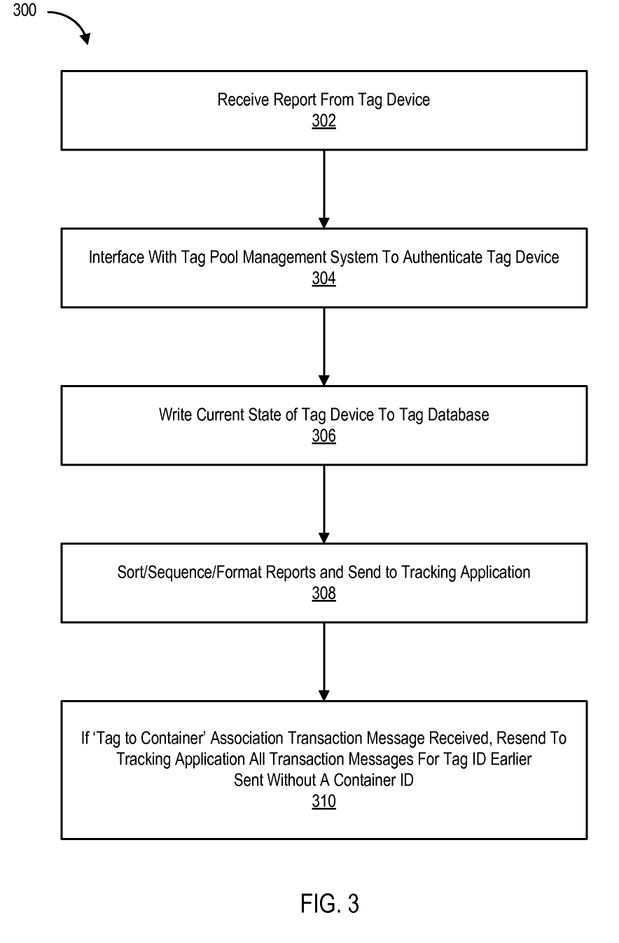

FIG. 3 is a flow diagram of an example process 300 performed by the location/status server (e.g., the location/status server 112 of FIG. 1). The steps of process 300 need not occur sequentially or in the order described below.

In some implementations, the process 300 begins when the location/status server receives a report from a Tag (302). The location/status server validates that mandatory fields in the report are populated. The location/status server interfaces with the tag pool management system (e.g., the TPMS 114) to authenticate the Tag (304). The location/status server writes the current status of the Tag to the tag database (e.g., tag database 116), which is accessible by the tag pool management system (306). The tag pool management system acts as a registry of Tags. In addition to storing the current state of each Tag, the tag pool management system can use the tag database to keep records of Tag allocations to customers.

The location/status server sorts or sequences reports received from Tags and forwards them to a tracking application operated by an information service (308). The location/status server can also format the reports to comply with processing logic of the tracking application. If a ‘Tag to Container’ association transaction message is received by the location/ status server, the location/ status server resends to the tracking application all transaction messages for the tag ID that were earlier sent without a container ID (310). In some implementations, these earlier transaction messages can be sent in sorted, chronological order.

### Example Process Performed by Information Service

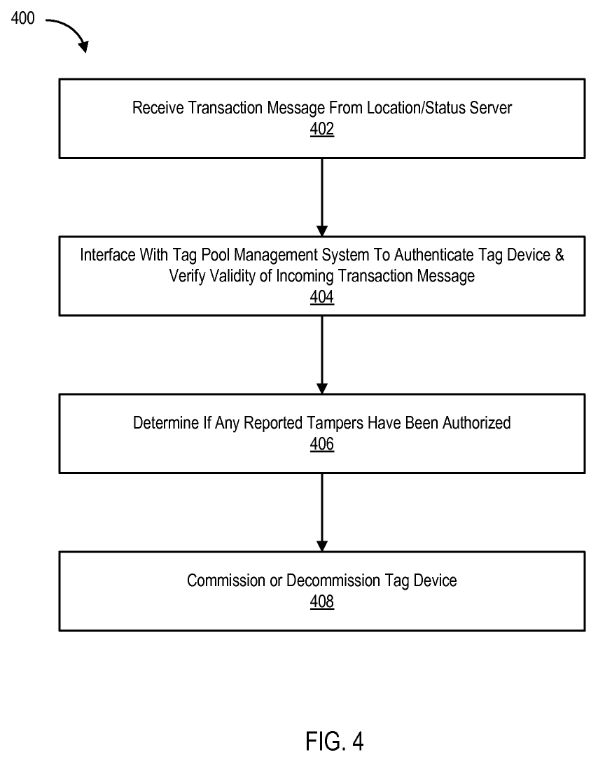

FIG. 4 is a flow diagram of an example process 400 performed by a tracking application implementing business logic. The steps of process 400 need not occur sequentially or in the order described below.

In some implementations, the process 400 begins when the tracking application (e.g., running on transaction server 124) receives incoming Tag transaction messages from the location/status server (402). The tracking application validates the Tag by interfacing with the tag pool management system (404). The tracking application also verifies the validity of the incoming Tag transaction messages. The tracking application verifies if a reported tamper state is authorized or has occurred in a valid, geo-fenced location indicating authorized opening of the container (406). A geo-fence is a virtual fence for any location (e.g., city, port, terminal) that is defined in the tracking application. The tracking application commissions or decommissions Tags and assets (408). The associated Tag ID and container ID resulting from commissioning are stored in the tag database.

The system 100 and processes 200, 300 and 400 described above can be used to implement various use cases, some examples of which are described below.

### Use Case No. 1—Commissioning Using IVR System

In all the commission use cases described below, a user wants to systematically associate a Tag to the asset/shipping container on which it is mounted, to facilitate tracking in a tracking application. The user can be a dock worker who mounts the Tag to the container or any other individual in the supply chain that is responsible for the asset (e.g., logistics service provider).

In some implementations, an IVR system (e.g., IVR system 120) is integrated with a tracking application that interacts with a user through a mobile or land phone and converts user responses (e.g., voice and/or key input) into messages that can be processed and stored in the tracking application to commission or decommission a Tag. The user mounts the Tag to the container, then calls a dedicated phone number. The IVR system authenticates the user and provides a selection menu (e.g., audio or visual menu). In some implementations the IVR system includes multi-lingual capability. User authentication can be accomplished by the user entering a password (e.g., an employee ID). The user selects a menu option to commission the Tag. The user enters a Tag identifier ID and a container ID. The IVR system confirms the data entry with the user and converts the IDs into a transaction message.

The incoming transaction message is processed and stored in the tracking application. The tag is associated to the container in the tracking application. An example transaction message is an Extensible Mark up Language (XML) message. The tracking application can apply one or more business rules to the transaction, such as verifying “check digits” of the container ID against International Organization for Standardization (ISO) container IDs. A “check digit” is defined in the ISO standard to consist of one (Arabic) numeric digit providing a means of validating the recording and transmission accuracies of the owner code and serial number. In some implementations, if the tag ID is invalid, the failed message is added to an exception queue (e.g., a queue in failed transaction database 126) with a reason code to be reviewed by the process owner.

### Use Case No. 2—Commissioning Using SMS

In some implementations, SMS messages sent via cell phone are integrated into a tracking application. In this case, the user sends an SMS message using his cell phone (or other device with messaging capability) to a predefined destination with information to identify the desired action. The SMS message can be constructed in a predefined format to identify the action as ‘Commissioning’. For example, the letter ‘C’ can be used to designate Commissioning. The SMS message can also include a predefined format for indicating the Tag ID and associated container ID, such as <Container Number’-‘Tag ID’>.

The user can be authenticated by 2-way SMS. For example, the user sends an SMS message via cell phone. The message reaches the tracking application successfully and the tracking application, in turn, sends a ‘request for authentication’ message back to the user. The user responds back with a designated password. The tracking application confirms the password and proceeds to process the original SMS message. In some implementations, the tracking application can process SMS messages from both Code Division Multiple Access (CDMA) and Global System for Mobile (GSM) networks.

In some implementations, the SMS message sent by the user can be converted into an XML message and sent to the tracking application. The incoming message is processed and stored in the tracking application. An ‘association was successful’ message can be sent back to the call ID that initiated the SMS message. The Tag ID is associated with the container ID in the tracking application.

A failed transaction message can be added to an exception queue with a reason code, to be reviewed by the process owner. An error message can be sent back to the caller ID that initiated the message. One or more business rules can be applied to the transaction, such as verifying check digits to validate container IDs.

### Use Case No. 3—Commissioning Using Email

In some implementations, email (SMTP) messages are used to relay association information to the tracking application. In this case, the user sends an email message using a computer or other email capable device to a predefined mailbox with a predefined format to identify the action desired, such as ‘C’ for Commissioning. A predefined format for the Tag and the associated container can be, for example, <Container Name’-‘Tag ID’>. The email is processed and stored in the tracking application. A success email message is sent back to the initiating email address. The Tag is associated to the container in the tracking application.

Failed messages can be sent to an exception queue with a reason code, to be reviewed by the process owner. An error email message can be sent to the same email address from which the email originated. User authentication can be accomplished by employing Sender Policy Framework (SPF) in an email server (e.g., message server 118). One or more business rules can be applied to the transaction, such as verifying check digits to validate container IDs.

### Use Case No. 4—Commissioning Using Hand-Held Application

In some implementations, a light-weight, mobile application can be downloaded to a hand-held computer/device to enable commissioning of a Tag. In this case, the user launches the application on a hand-held computer or device. The user selects an option to commission a Tag to a container and enters the Tag ID and the container ID. The mobile application communicates with the tracking application and uploads the information to the tracking application. The message is processed and stored in the tracking application. An ‘association was successful’ message is sent back to the mobile application. The Tag is associated to the Container in the tracking application.

User authentication can be accomplished by a user ID and password to download the mobile application on the hand-held device initially. During the download process, the authentication information can be stored on the hand-held device (e.g., as a cookie). One or more business rules can be applied to the transaction, such as verifying check digits to validate container IDs.

### Use Case No. 5—Commissioning Using Web Interface

In some implementations, a web form can be provided by a Web server that enables a user to commission or decommission containers to Tags. In this case, the user logs into the tracking application and launches the ‘ZCC Activity’ page. The user enters the Tag ID and the container ID to be associated and marks them to be commissioned. The tracking application processes and stores the information. A success/failure message can be presented to the user. The Tag is associated to the container in the tracking application. A WAP (wireless application protocol)-version of the web interface can also be presented in the mobile browser of a mobile device (e.g., Safari™ on the iPhone™).

In some implementations, the user has multiple Tags and containers to be commissioned. The user can keep tab of the multiple Tags and the containers to be associated, in a spreadsheet on the user's desktop. The user copies the table of multiple Tags and associated containers from the spreadsheet and pastes the table into the web form, then presses <enter>. The tracking application processes and stores the information. Success/failure messages can be presented to the user for every Tag ID/Container ID association.

User authentication can be accomplished by successfully logging into the tracking application with a valid user ID and password. One or more business rules can be applied to the transaction, such as verifying check digits to validate container IDs.

### Use Case No. 6—Commissioning Using EDI 304 (Shipping Instructions)

In some implementations, the tag-to-container association is sent as part of a shipping instruction via an EDI 304 message. In this use case, the shipper or a logistics service provider sends the tag-to-container association as part of the shipping instructions (part of an EDI 304 message), and a copy of the shipping instructions is received by the tracking application. The tracking application receives the shipping instructions successfully and optionally sends a functional acknowledgement (e.g., an EDI 997 message) back to the sender. The tracking application processes and stores the shipping instructions. The Tag ID is associated to the Container ID in the tracking application.

Failed EDI messages can be added to an exception queue with a reason code, to be reviewed by the process owner. Authentication can be accomplished by establishing valid sender and receiver IDs in the EDI messages. In case of multiple containers, the Tag information for each container can be accommodated within the same EDI 304 transaction message. One or more business rules can be applied to the transaction, such as verifying check digits to validate container IDs.

### Use Case No. 7—Commissioning Using EDI 310 (Bill of Lading)

In some implementations, tag-to-container association is sent as part of the Bill of Lading via an EDI 310 message. In this case, the carrier (e.g., ocean carrier) relays the tag-to-container association that was sent to the carrier via the EDI 304 message. A copy of the EDI 310 message is received into the tracking application. The tracking application receives the EDI 310 message successfully and optionally sends an EDI 997 message back to the sender. The tracking application processes and stores the EDI 310 message. The Tag ID is associated to the Container ID in the tracking application.

Failed EDI messages can be added to an exception queue with a reason code to be reviewed by the process owner. Authentication can be accomplished by establishing valid sender and receiver IDs in the EDI messages. In case of multiple containers, the Tag information for each container can be accommodated within the same EDI 310 transaction message. One or more business rules can be applied to the transaction, such as verifying check digits to validate container IDs.

### Use Case No. 8—Commissioning Using EDI 315 (Ocean Status Update Message)

In some implementations, tag-to-container association is sent as part of the ocean status update transaction via an EDI 315 message. In this case, the carrier (e.g., ocean carrier) sends the tag-to-container association as part of the EDI 315 ocean status update message and a copy of the EDI 315 message is received into the tracking application. The tracking application receives the EDI 315 message successfully and optionally sends an EDI 997 message back to the sender. The tracking application processes and stores the EDI 315 message. The Tag ID is associated to the Container ID in the tracking application.

Failed EDI messages can be added to an exception queue with a reason code to be reviewed by the process owner. Authentication can be accomplished by establishing valid sender and receiver IDs in the EDI messages. In case of multiple containers, the Tag information for each container can be accommodated within the same EDI 315 transaction message. One or more business rules can be applied to the transaction, such as verifying check digits to validate container IDs.

### Use Case No. 9—Commissioning Using EDI 214 (Truck Status Update Message)

In some implementations, tag-to-container association is sent as part of the truck status update transaction via an EDI 214 message. In this case, the carrier (e.g., truck carrier) sends the tag-to-container association as part of the EDI 214 ocean status update message and a copy of the EDI 214 message is received into the tracking application. The tracking application receives the EDI 214 message successfully and optionally sends an EDI 997 message back to the sender. The tracking application processes and stores the EDI 214 message. The Tag ID is associated to the Container ID in the tracking application.

Failed EDI messages can be added to an exception queue with a reason code to be reviewed by the process owner. Authentication can be accomplished by establishing valid sender and receiver IDs in the EDI messages. In case of multiple containers, the Tag information for each container can be accommodated within the same EDI 214 transaction message. One or more business rules can be applied to the transaction, such as verifying check digits to validate container IDs.

### Use Case No. 10—Commissioning Using EDI 301 (Booking Confirmation)

In some implementations, tag-to-container association is sent as part of the Booking confirmation via an EDI 301 message. The carrier transmits the EDI 301 (Booking confirmation) message. A copy of the EDI 301 message is received into the tracking application. The tracking application receives the EDI 301 message successfully and optionally sends an EDI 997 back to the sender. The tracking application processes and stores the EDI 301 message. The Tag ID is associated to the Container ID in the tracking application.

In some implementations, the shipper requests containers as part of their booking request (e.g., via EDI 300 message or via fax, phone, etc.). In this case, the carrier acts as forward-positioning agent; the Tags are already affixed to the containers before the containers are sent to the shipper for stuffing/loading. The carrier transmits the tag-to-container association as part of the EDI 301 (Booking confirmation) message. A copy of the EDI 301 message is received into the tracking application. The tracking application receives the EDI 301 message successfully and optionally sends an EDI 997 message back to the sender. The tracking application processes and stores the EDI 301 message in the tracking application. The user is now able to track the exact location of the container in the tracking application.

### Tag-To-Container Decommissioning

The same modes of communications used for Tag-To-Container commissioning can be used for decommissioning. In these cases, the user wants to systematically disassociate a Tag that is mounted onto a container to stop tracking the container in the tracking application. For IVR, SMS, email, hand-held applications and Web interface modes of communication, decommissioning is performed in a similar manner as commissioning except that appropriate decommission options are selected by the user. For example, a decommissioning action can be identified in an SMS message by ‘D’ for Decommissioning.

### Use Case—Infer ‘End Journey’ & Automatic Decommissioning

In some implementations, the tracking application can logically infer an ‘End of Journey’ state ‘X’ days after the actual arrival at the final destination. The actual arrival can be determined by a position fix at the final destination location sent by the Tag. In this case, the tracking application wants to disassociate a Tag that is mounted onto a container to stop tracking the container in the tracking application. The tracking application checks periodically for all Tags that are still associated to containers ‘X’ days after actual arrival at the final destination and automatically decommissions those Tags from their associated containers.

### Use Case—Geo-Fence Validation

In some implementations, the tracking application logically infers ‘End of Journey’ state if a tamper alert is received for the Tag at a valid, geo-fenced final destination location. In this case, the tracking application receives a GPRS report for the Tag with the current location and tamper state (e.g., a ‘Door Open’ alert). If the Tag registers a tamper alert at a valid, geo-fenced final destination location, the tracking application decommissions the Tag from the Container.

### Use Case—Authorized (Customs) Inspection

In some implementations, several zero-client options can be used for notification of an authorized inspection of a container to the tracking application. The inspection could be performed by customs agents or other agents of the “parties to the transaction (shipment)” who are authorized to perform inspections and/or clear tamper or environmental exception states. The notification of an authorized opening of the container can be issued without the involvement of any dedicated device.

In this case, the customs inspector or other agent calls a dedicated phone number using a cell phone or land phone before unmounting the Tag and opening the container. An IVR system verifies/authenticates the user and provides a selection menu. The user selects an option to notify customs inspection. The user enters the container ID. The IVR system confirms the data entry with the user. The IVR system converts the information into a message (e.g., an XML message) and sends the message to the tracking application. The incoming message is processed and stored by the tracking system. The tracking system reconciles the tamper alert that it receives from the Tag (after the inspector unmounts the Tag) as an authorized customs inspection. In some implementations, the customs inspector can notify the tracking application as described above after opening the container. In this use case, the tracking application reconciles the tamper alert that the tracking application previously received from the Tag as an authorized customs inspection.

Other modes of communication (e.g., SMS, email, hand-held application, Web interface, EDI) can be used for this use case. For each communication mode, the tracking system reconciles the tamper alert that it receives from the Tag as an authorized customs inspection only if the tamper alert is received after the inspector unmounts the Tag from the container. In some implementations, the custom inspector notifies the tracking application after opening the container. In this use case, the tracking application reconciles the tamper alert that it previously received from the Tag as an authorized customs inspection.

### Use Case—Geo-Fence Validation

In some implementations, the tracking application logically infers ‘Authorized Customs Inspection’, if a tamper alert is received for the Tag at a designated customs area that has been geo-fenced. In this case, a notification of the authorized opening of a container for customs inspection is communicated to the tracking application. The tracking application receives a GPRS report from the Tag with the current location and tamper state. The tracking application reconciles the tamper alert that it received from the designated, geo-fenced customs area, as an authorized customs inspection. If the container is in a designated customs area that has not been geo-fenced, the tracking application fails to identify the new location as a valid customs area and reports an unauthorized opening of the container.

The features described can be implemented in digital electronic circuitry, or in computer hardware, firmware, software, or in combinations of them. The features can be implemented in a computer program product tangibly embodied in an information carrier, e.g., in a machine-readable storage device or in a composition of matter capable of effecting a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving a request from a device to associate a tag with an asset coupled to the tag, the request made by a user of the device;
authenticating the user of the device;
responsive to a successful authentication, receiving a tag identifier and an asset identifier from the user through the device; and
associating the tag identifier and the asset identifier.

2. The method of claim 1, further comprising:
receiving geographic location data from the tag; and
tracking the asset using the geographic location data and the associated tag identifier and asset identifier.

3. The method of claim 1, where the request and identifiers are received using an integrated voice response system.

4. The method of claim 3, where the integrated voice response system has multi-lingual capabilities.

5. The method of claim 3, where the integrated voice response system receives touch tones representing the request and the tag and asset identifiers.

6. The method of claim 1, further comprising:
converting the tag identifier and asset identifier into a message and sending the message to an asset tracking application operable for tracking the asset.

7. The method of claim 1, where the authenticating includes receiving a password from the user through the mobile device and verifying the password.

8. The method of claim 1, where at least one of the request, the tag identifier and the asset identifier is received using Short Message Service (SMS).

9. The method of claim 1, where at least one of the request, the tag identifier and the asset identifier is received using email.

10. The method of claim 1, where at least one of the request, the tag identifier and the asset identifier is received using a web interface presented on the device.

11. The method of claim 1, where at least one of the request, the tag identifier and the asset identifier is received using electronic message sharing.

12. A computer-implemented method comprising:
receiving a request from a device to disassociate a tag and an asset decoupled from the tag, the request made by a user of the device;
authenticating the user of the device;
responsive to a successful authentication, receiving a tag identifier and an asset identifier from the user through the device; and
disassociating the tag identifier from the asset identifier.

13. The method of claim 12, where the request and identifiers are received using an integrated voice response system.

14. The method of claim 13, where the integrated voice response system has multi-lingual capabilities.

15. The method of claim 13, where the integrated voice response system receives touch tones representing the request and the tag and asset identifiers.

16. The method of claim 12, further comprising:
converting the tag identifier and asset identifier into a message and sending the message to an asset tracking application operable for ceasing tracking of the asset in response to the message.

17. The method of claim 12, where the authenticating includes receiving a password from the user through the device and verifying the password.

18. The method of claim 12, where at least one of the request, the tag identifier and the asset identifier is received using Short Message Service (SMS).

19. The method of claim 12, where at least one of the request, the tag identifier and the asset identifier is received using email.

20. The method of claim 12, where the tracking application infers disassociation after a predetermined time period expires after the asset arrives at a designated final destination.

21. The method of claim 12, where at least one of the request, the tag identifier and the asset identifier is received using a web interface presented on the device.

22. The method of claim 12, where at least one of the request, the tag identifier and the asset identifier is received using electronic message sharing.

23. A computer-implemented method comprising:
receiving a report associated with a tag coupled to an asset, the report including a then current geographic location of the tag and a tamper alert;
determining if the tag registered the tamper alert at a valid, geo-fenced final destination location;
if the tag registered the tamper alert at a valid, geo-fenced final destination location, disassociating the tag and the asset; and
if the tag did not register the tamper alert at a valid, geo-fenced final destination location, maintaining an association between a tag identifier and an asset identifier.

24. The method of claim 22, further comprising:
determining if the tamper alert is associated with arrival at the final destination of the asset; and
if the tamper alert is not associated with the arrival at the final destination of the asset, maintaining the tamper alert as an illegal tamper of the asset.

25. The method of claim 22, further comprising:
logically inferring disassociation of the tag from the asset if the tamper alert is registered at the geo-fenced, final destination of the asset.

26. A computer-readable medium having instructions stored thereon, which, when executed by a processor causes the processor to perform operations comprising:
receiving a request from a device to associate a tag with an asset coupled to the tag, the request made by a user of the device;
authenticating the user of the device;
responsive to a successful authentication, receiving a tag identifier and an asset identifier from the user through the device; and
associating the tag identifier and the asset identifier.

27. The computer-readable medium of claim 26, where at least one of the request, the tag identifier and the asset identifier is received using one or more of an Integrated Voice Response (IVR) system, Short Message Service (SMS), email, web interface and a mobile application.

28. A computer-readable medium having instructions stored thereon, which, when executed by a processor causes the processor to perform operations comprising:
receiving a request from a device to disassociate a tag and an asset decoupled from the tag, the request made by a user of the device;
authenticating the user of the device;
responsive to a successful authentication, receiving a tag identifier and an asset identifier from the user through the device; and
disassociating the tag identifier from the asset identifier.

29. The computer-readable medium of claim 28, where at least one of the request, the tag identifier and the asset identifier is received using one or more of Integrated Voice Response (IVR) system, Short Message Service (SMS), email, Web interface, Electronic Data Interchange (EDI) and a mobile application.

30. A computer-readable medium having instructions stored thereon, which, when executed by a processor causes the processor to perform operations comprising:
receiving a report associated with a tag coupled to an asset, the report including a then current geographic location of the tag and a tamper alert;
determining if the tag registered the tamper alert at a valid, geo-fenced final destination location;
if the tag registered the tamper alert at a valid, geo-fenced final destination location, disassociating the tag and the asset; and
if the tag did not register the tamper alert at a valid, geo-fenced final destination location, maintaining an association between a tag identifier and an asset identifier.

31. The computer-readable medium of claim 30, further comprising:
determining if the tamper alert is associated with an authorized inspection of the asset; and
if the tamper alert is not associated with an authorized inspection of the asset, reporting an authorized inspection of the asset.

32. The computer-readable medium of claim 30, further comprising:
logically inferring an authorized inspection of the asset if the tamper alert is received for the tag at a designated customs inspection location that has been geo-fenced.

33. A computer-implemented method comprising:
receiving a first request using a first mode of communication to associate or disassociate a tag with an asset coupled to the tag, where the first request is received from a first requestor at a first point in transit of the asset;
authenticating the first requestor;
responsive to a successful authentication of the first requestor, receiving a tag identifier and an asset identifier from the first requestor;
associating or disassociating the tag identifier and the asset identifier;
receiving a second request using a second mode of communication to associate or disassociate the tag with the asset coupled to the tag, where the second request is received from a second requestor at a second point in transit of the asset;
authenticating the second requestor;
responsive to a successful authentication of the second requestor, receiving the tag identifier and the asset identifier from the second requestor; and
associating or disassociating the tag identifier and the asset identifier.

34. The method of claim 33, where the first or second mode of communications are from the group of communication modes consisting of an Integrated Voice Response (IVR) system, Short Message Service (SMS), email, Web interface, Electronic Data Interchange (EDI), and a mobile application.
